(19) United States
(12) Patent Application Publication
(10) Pub. No.: US 2002/0101982 A1
(43) Pub. Date: Aug. 1, 2002

(54) Line echo canceller scalable to multiple voice channels/ports

(76) Inventor: Hammam Elabd, Sunnyvale, CA (US)

Correspondence Address: Pillsbury Winthrop LLP, Ninth Floor, East Tower, 1100 New York Avenue, Washington, DC, 20005-3918, US

(21) Appl. No.: 09/774,482

(22) Filed: Jan. 30, 2001

(51) Int. Cl. H04M 9/08

(52) U.S. Cl. 379/406.01

(57) ABSTRACT

The present invention relates to a system and method for canceling echoes from telecommunications networks by providing a system on chip having a line echo canceller and tone detector. Unlike conventional echo cancellers, the present invention uses a chip to cancel echoes that are generated in the network. In addition, the echo canceller of the present invention performs line echo cancellation, far end echo cancellation, acoustic and hybrid echo cancellation, noise processing, fax/data tone detection, DTMF, and digital timing. The present invention uses multiplexed analog delay lines, analog multipliers and adders/subtractors to perform and accelerate echo canceling, thereby enhancing channel density and optimizing scalable design of the chip and avoiding expensive chip with large on-chip logic and memory that is typically required in digital echo cancellers.

### FIELD OF THE INVENTION

The present invention relates to the field of echo cancellers, and more particularly, to a line echo canceller. The present invention is also directed to a method and system for canceling echoes associated with digital, analog, and mixed signals. It is further directed to echo cancellers implemented on a chip or system on chip (SOC).

### BACKGROUND OF THE INVENTION

Analog, digital, and mixed signal phones (hardwired and wireless) and networks are increasingly being regarded as essential communication tools in today's marketplace. As new network infrastructures are implemented and competition between communication providers increases, subscribers are becoming ever more critical of the quality of service they receive from such providers. Subscribers often use speech quality as one of the benchmarks for assessing the overall quality of a telephone and network. For this reason, removal of hybrid and/or acoustic echoes inherent within many network infrastructures is the key to maintaining and improving voice quality on a call. This has led to intensive research in the area of echo cancellation with the purpose of providing solutions that can reduce background noise and remove line echo (hybrid) and acoustic echoes.

Acoustic echoes can be generated from both analog and digital handsets. This type of echo is generated by poor voice coupling between the earpiece and microphone in handsets or hands-free devices. Acoustic echoes can be prevalent in video/audio-conferencing studios, as well as in mobile situations, e.g., when people are driving their cars. In this situation, sound from a speaker is heard by a listener, as intended, but the microphone also picks up this same sound, both directly and indirectly, after bouncing off the roof, windows, and seats of the car. This results in multi-path echo, which, unless eliminated, are transmitted back to the distant end subscriber and are heard by him/her as echoes. As can be expected, predominant use of hands-free telephones in offices has exacerbated this acoustic echo problem.

Hybrid or line echoes are the primary source of echoes generated from a public switched telephone network (PSTN) and packet network. These electrically generated echoes are created when voice signals are transmitted across the network via a hybrid connection at two-wire/four-wire PSTN conversion points, thereby reflecting electrical energy back to the speaker from the four-wire circuit. Stated alternatively, in PSTN and packet network based telephone networks, echoes are generated when a speaker's speech is reflected back to him/her from a hybrid interface.

In greater detail, FIG. 1 illustrates a conventional hybrid interface 4 that is connected to a near end subscriber 2 through a two-wire line and to a far end subscriber 10 through a four wire line. The four-wire line is used for transmission of analog or digital signals within a local exchange. Any speech at point 6 generated by the far end subscriber 10 that re-emerges at point 8 via the hybrid interface 4 is known as the hybrid echo. As voice signals pass from the four-wire line to the two-wire line, the energy in the four-wire line is reflected back on itself, creating the echoed speech. Provided that the total round trip delay occurs within just a few milliseconds (e.g., within <<28 ms), it generates a sense that the call is live by adding side tone, which makes a positive contribution to the quality of the call.

In cases where the total network delay time exceeds e.g., 36 ms, the positive benefits disappear and intrusive echoes result. The amount of signals that are reflected back to the far end subscriber 10 depends on how well a balance circuit (not shown) of the hybrid interface 4 matches the two-wire line. In most cases, the balance is poor, resulting in a considerable amount of signals reflecting back to the far end subscriber 10. This is known as the echo return loss (ERL), and the higher the ERL, the lower the reflected signals back to the far end subscriber 10, and vice versa.

As a result, speech at point 8 that is transmitted to the far end subscriber 10 may include speech from the near end subscriber 2 and echoes generated by the hybrid interface 4 or subsequent hybrids. Such echoes may be annoying, and under certain conditions can completely disrupt a conversation between the far end subscriber 10 and the near end subscriber 2. To attenuate such echoes, filters are generally used in these networks.

In other situations, digital processing delays and speech-compression techniques further contribute to echo generation and degraded voice quality. Delays are encountered as signals are processed through various routes within the networks, including copper wires, fiber optic lines, microwave connections, international gateways, and satellite transmission. This is especially true with mixed signal networks where calls are processed across numerous network infrastructures.

One conventional echo cancellation method uses a transformer with a number of passive elements. As described above, echoes are generated in telecommunication networks due to impedance mismatches at hybrid transformers that couple the two wire line to the four wire line. Ideally, the hybrid transformer transmits the far end subscriber's speech signals at the four wire receive port to the two wire transmit port without leakage into the four wire transmit port. However, this would require exact knowledge of the impedance seen at the two wire port, which varies widely and can only be estimated. As a result, leakage signals in the form of echoes are transmitted to the far end subscriber.

Another conventional method for canceling echoes is known as an adaptive digital filter. FIG. 2 is a block diagram illustrating an arrangement having a conventional echo canceller 20. In general, adaptive digital filters 22 are used to replicate different impulse responses associated with telephones and to compensate for variations in the impulse responses caused by changes in the subscriber loops.

In this conventional system, digital speech signals at point 16 from the far end subscriber 10 are converted to analog signals by a digital to analog converter (not shown) before the signals reach the hybrid interface 4. Speech signals from the near end subscriber 2 and/or echoes generated by the hybrid interface 4 are converted to digital signals by an analog to digital (A/D) converter (not shown) before such signals are transmitted to a subtractor 30.

Simultaneously, one or more adaptive filters 22 (i.e. least means squares (LMS) digital filters) in an echo canceller 20 receive the far subscriber speech signals from point 16. Filters using other algorithms such as recursive least squares (RLS) may be substituted for the LMS digital filters. The adaptive filters 22 generate synthetic echoes based on the real speech signals from the far end subscriber 10. The synthetic echoes are then subtracted from the real echoes using the subtractor 30, thus reducing the echoes transmitted to the far end subscriber 10. Subtracting the synthetic echoes from the real echoes will reduce the amplitude of the echoes, and the remaining signals after this subtraction are known as “error signals.” The error signals are transmitted to the adaptive filters 22 where the coefficients therein are adjusted accordingly in an effort to minimize future echoes from being transmitted to the far end subscriber 10. Adaptive methods such as that described above generally rely on information contained in the speech signals from the far end subscriber 10. Adaptive filters 22 generally include coefficients that are updated/adjusted based on the LMS or RLS algorithm.

There are generally two key performance parameters of an echo canceller: ERLE (echo return loss enhancement) and converge time. The ERLE is the degree to which the echo canceller suppresses the echoes, i.e., the ratio between the real echoes and the echo error signals measured in dB. The converge time is the time required to reach an ERLE of 26 dB or greater.

With the advent of voice packet technology, i.e., Voice over Internet Protocol (VoIP), echo cancellers are becoming increasingly important. This is because the latency and transmission delay of an IP network is much longer than that of a traditional TDM network. Because a human's perception of an echo is proportional to its delay, controlling its ERLE and converge time is highly desirable for optimal voice quality.

FIG. 3 illustrates a conventional VoIP network implementing echo cancellers. A first subscriber's telephone 42a is connected to a first PSTN switch 44a, which itself is connected to a first VOX (voice operated exchange) gateway 46a. Likewise, a second subscriber's telephone 42b is connected to a second PSTN switch 44b, which itself is connected to a second VOX gateway 46b. Each VOX gateway 46a, 46b includes an echo canceller 48a, 48b, respectively, and is connected to the other via a VOX network 50. As described earlier herein, each echo canceller 48a, 48b cancels the echoes originating from the telephones 42a, 42b, respectively.

FIG. 4 illustrates a conventional wireless network implementing an echo canceller. In this figure, a wireless telephone subscriber 60 communicates with a second subscriber, the second subscriber using a telephone 70. When the wireless subscriber 60 makes a call, the voice signals are transmitted through a cell site 62, an echo canceller 64, and a mobile switching center 66 to the hybrid interface 68. These voice signals are then transmitted to the telephone 70, thereby establishing a communication session between the two subscribers. The voice signals from the telephone 70 and/or the echoes generated by the hybrid interface 68 are transmitted back to the wireless subscriber 60 via the mobile switching center 66, the echo canceller 64, and the cell site 62. The echo canceller 64 cancels the echoes generated by the hybrid interface 68 so that the wireless subscriber 60 receives more improved speech.

FIG. 5 illustrates a more detailed block diagram of a conventional echo cancellation system. As is well known, the conventional system includes a double-talk detector 80 that functions by correlating near-end and far-end power estimation signals. The double-talk detector 80 concludes that the two subscribers are speaking simultaneously if the far end and near end signals exceed threshold values several times within an observation period. A convolution processor 82 coupled to the double-talk detector 80 consists of two registers commonly known as an X-register and an H-register. The convolution processor 82 is generally used to generate a real-time, dynamic estimate of the echoes originating from either of the subscribers. The inputs into the convolution processor 82 can be from the double-talk detector 80, receiving signal, and/or the error signals from the subtractor 30.

The convolution process is as follows: the contents of the X-register are multiplied with the contents of the H-register to generate the echo estimate, which is fed to the subtractor 30. The X-register is used to store voice samples whereas the H-register is a mathematical representation of the hybrid's impulse response. The convolution of the X-register with the H-register produces an accurate estimate of the output (echo) of the hybrid.

There are typically two types of convolution processors that are used in echo cancellers. The first is the full-tapped processor that uses an H-register large enough to model the impulse response of the entire endpath and simultaneously model an unlimited number of echoes. The second is the windowed processor that uses an H-register much smaller than the actual endpath and can only cancel those echoes that fit within the H-register's window.

The subtractor 30 subtracts the echo estimate that was generated by the convolution processor 82 from the send path. The resulting output is the residual echo that is fed to a non-linear processor 84. The residual echo is also fed back to the convolution processor 82 as the error signal.

The echo canceller converges (i.e., minimizes) the error signal as the H-register develops a model of the endpath's impulse response. The non-linear processor 84 includes a suppression threshold that is typically adaptive and processes the signals before transmitting the signals to one of the subscribers.

In the current state of the art, echo cancellers as described above come in a variety of sizes and shapes. Most notably, conventional echo cancellers are packaged in large and bulky boxes/boards, whose height, width, and length are generally several feet each. Companies such as Lucent, Ditech, and Tellabs manufacture such echo cancellers and additional background information regarding echo cancellers that are manufactured by such companies can be obtained by viewing their web sites. Since it is highly undesirable to purchase, store (e.g., shelf space issues in the central office), etc. such large echo cancellers, what is needed in this industry is an echo canceller that can be implemented on a chip or system on chip (SOC).

### SUMMARY OF THE INVENTION

In view of the above problems of the prior art, it is an object of the present invention to provide an echo canceller that can be implemented on a system on chip.

It is another object of the present invention to provide a line echo canceller that can cancel echoes associated with digital, analog, and/or mixed signals.

It is still another object of the present invention to provide an echo canceller that can dynamically eliminate both acoustic and hybrid echoes.

It is yet another object of the present invention to provide an echo canceller that can be scalable to at least 672 channels per chip or 28 T1 lines or DS3 capacity.

It is a further object of the present invention to provide an echo canceller that can handle echo tail length of, for example, 64-128 ms.

These and other objects of the present invention are obtained according to an aspect of the present invention by providing an echo canceller that performs line echo cancellation, far end echo cancellation, acoustic and hybrid echo cancellation, noise processing, data and fax tone detection, DTMF, and digital timing. The present invention utilizes multiplexed analog delay lines, analog multipliers, and adders/subtractors to perform echo canceling, thereby optimizing scalable design of the chip and avoiding large on-chip logic, multipliers and memory that are typically required in digital echo cancellers. On-chip filters along with external components are used to perform the data and fax tone detection and may be the DTMF function on the chip.

The echo canceller of the present invention uses an accelerator chip made of charge coupled analog delay lines (instead of memory blocks) and floating diffusion amplifiers to convert charge to voltage, which is then fed to the on-chip analog multiplier and summing amplifier. In this manner, the echo canceller is highly scalable and performs the traditional echo canceling functions on the chip.

### BRIEF DESCRIPTION OF THE DRAWINGS

These and other objects and advantages of the present invention will become apparent and more readily appreciated from the following detailed description of the presently preferred exemplary embodiment of the invention taken in conjunction with the accompanying drawings, of which:

FIG. 1 illustrates a simplified block diagram showing a conventional two to four wire hybrid interface connecting a near end subscriber to a far end subscriber;

FIG. 2 illustrates a block diagram of an arrangement having a conventional adaptive echo canceller;

FIG. 3 illustrates a conventional VoIP network using echo cancellers;

FIG. 4 illustrates a conventional wireless network using an echo canceller;

FIG. 5 illustrates a more detailed block diagram of a conventional echo cancellation system;

FIG. 6 illustrates an implementation of a digital line echo canceller in accordance with a preferred embodiment of the present invention;

FIG. 7 illustrates a more detailed block diagram of a delay block and MAC block of the digital line echo canceller for large channel density in accordance with the preferred embodiment;

FIG. 8A illustrates a system level block diagram in accordance with a preferred embodiment of the present invention;

FIG. 8B illustrates a mixed signal implementation of a line echo canceller in accordance with the preferred embodiment;

FIG. 9 illustrates a more detailed block diagram of an analog accelerator chip in accordance with the preferred embodiment;

FIG. 10 illustrates a diagram of a summing op amp in accordance with the preferred embodiment;

FIG. 11A illustrates an op amp gain control in accordance with the preferred embodiment;

FIG. 11B illustrates a code controlled trans-conductance amp in accordance with the preferred embodiment;

FIG. 12A illustrates a representation of coefficients in accordance with the preferred embodiment;

FIG. 12B illustrates coefficient processing components in accordance with one of the preferred embodiment; and

FIG. 13 illustrates an analog implementation of a fax/data tone and DTMF detection in accordance with the preferred embodiment.

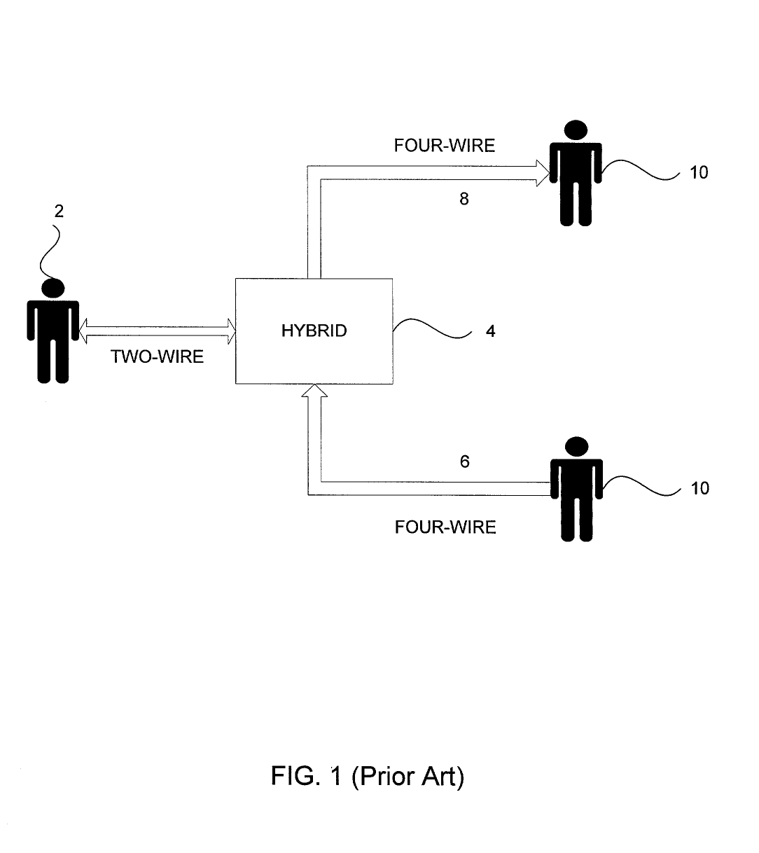

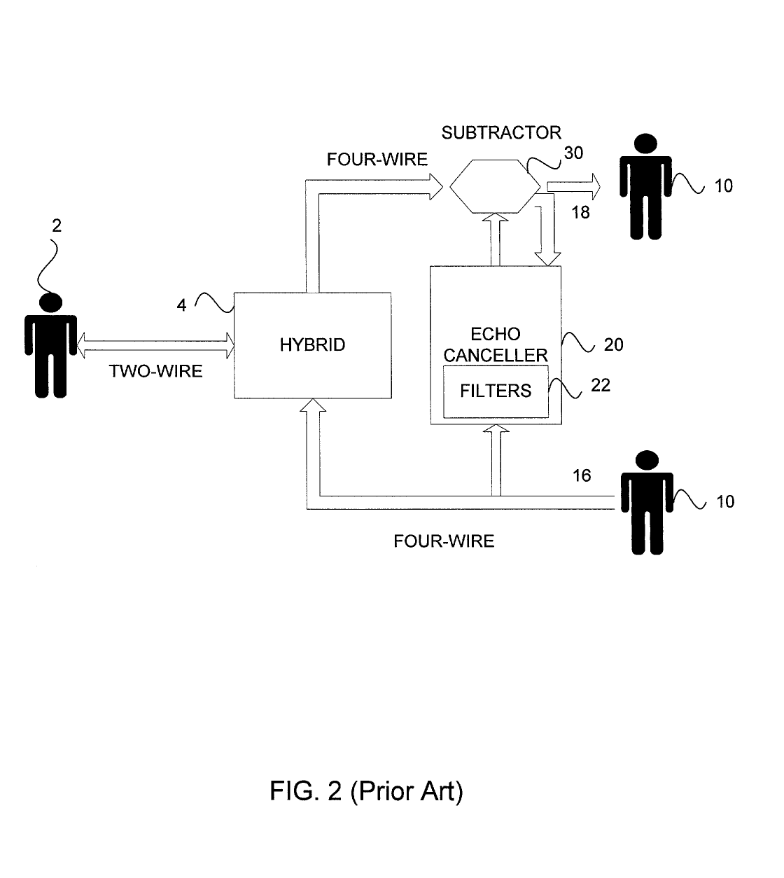

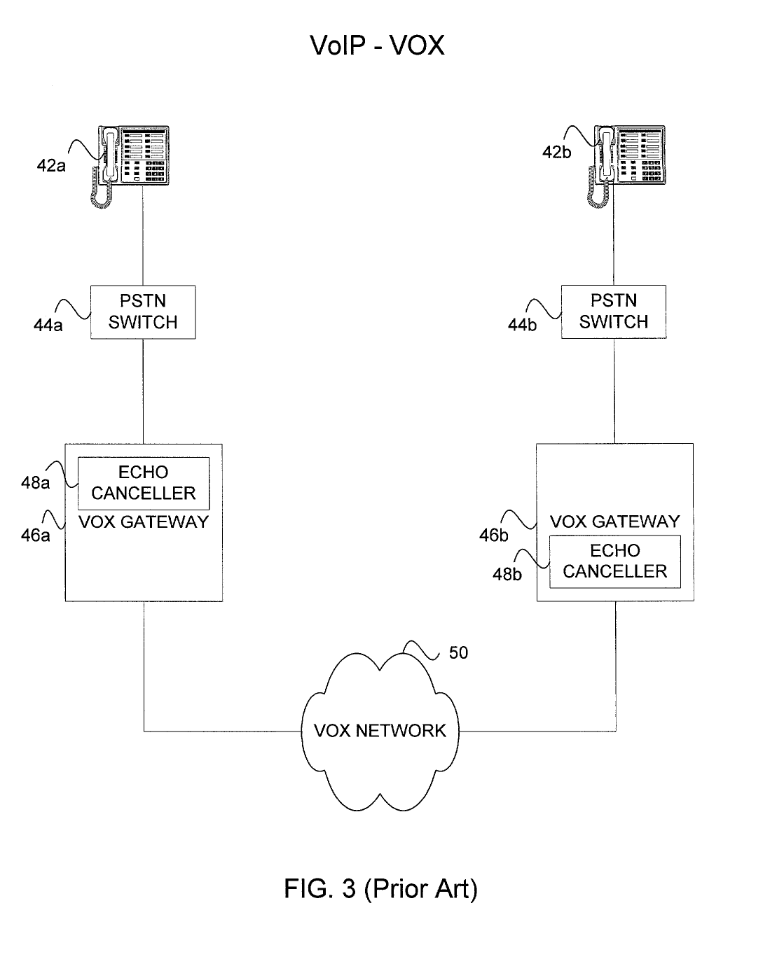

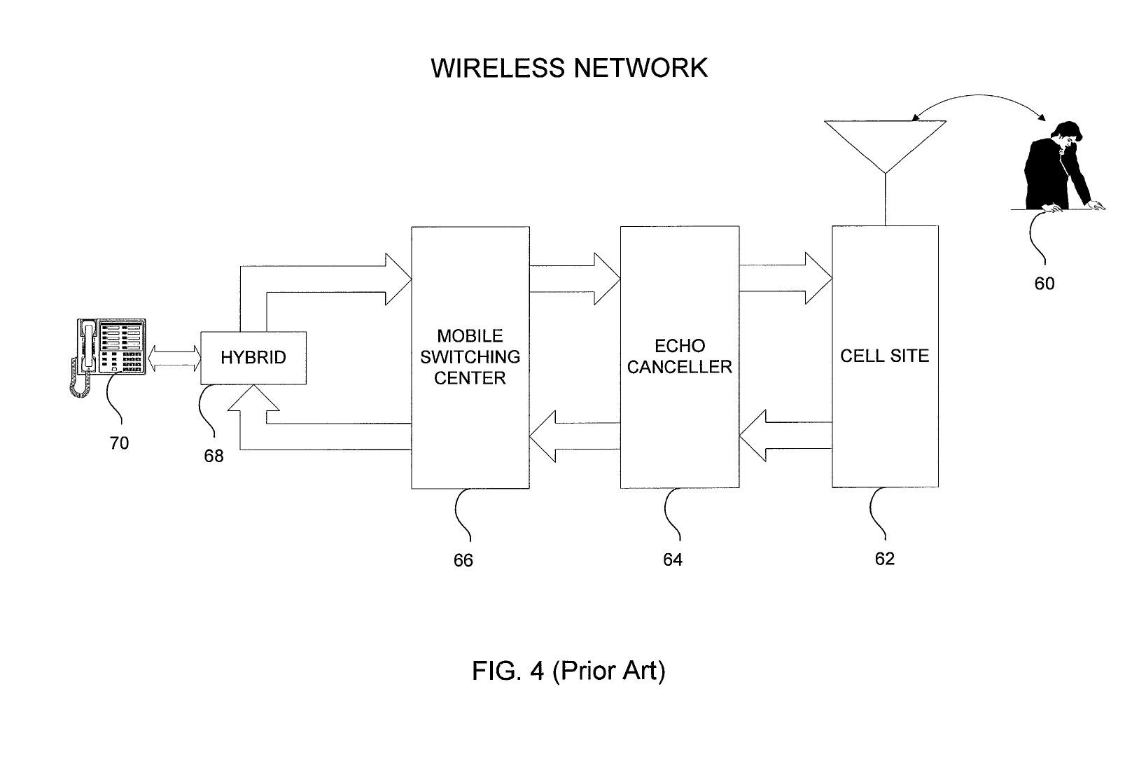

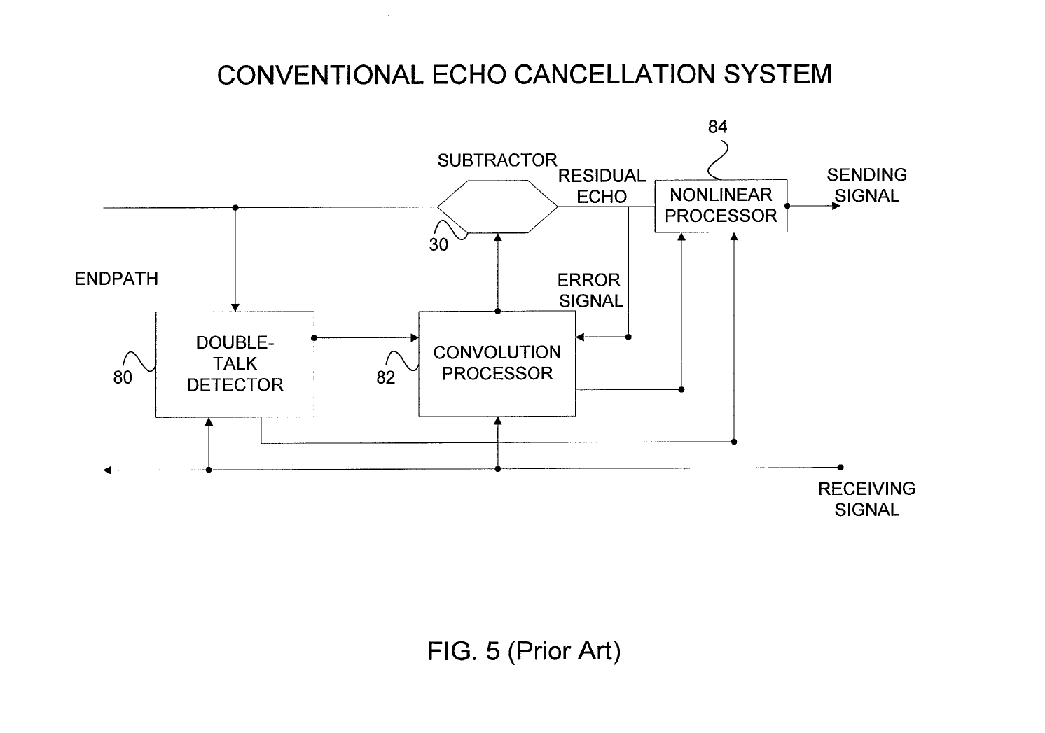

### DETAILED DESCRIPTION OF THE PREFERRED EMBODIMENTS

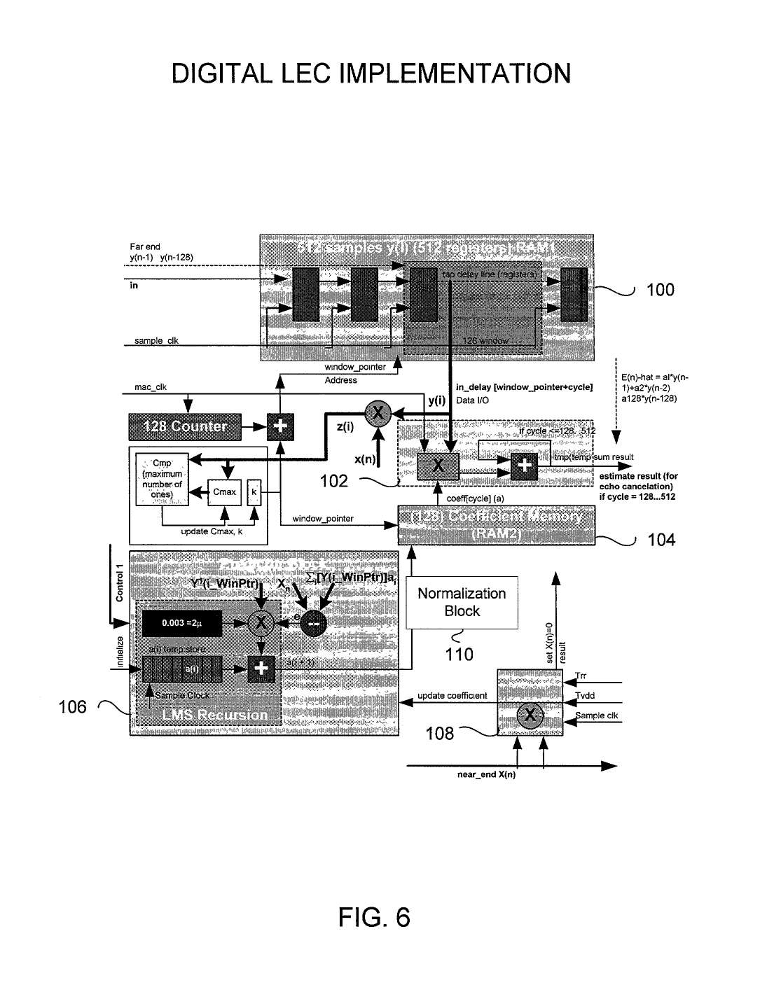

The present invention will be described in greater detail, which will serve to further the understanding of preferred embodiments of the present invention. As described elsewhere herein, various refinements and substitutions of the various embodiments are possible based on the principles and teachings herein. A preferred embodiment of the present invention will now be described with reference to FIGS. 6-13, wherein like components are designated by like reference numerals throughout the various figures. Further, specific parameters such as number of delay lines, speeds, data rates, and the like are provided herein, and are intended to be explanatory rather than limiting.

The present invention is directed to an echo canceller that can be implemented on a chip to dynamically eliminate both acoustic and hybrid echoes. The echo canceller performs line echo cancellation, far end echo cancellation, acoustic and hybrid echo cancellation, noise processing, fax/data tone detection, DTMF detection, and digital timing. The present invention utilizes multiplexed analog delay lines, analog multipliers and adders/subtractors to accelerate the performance of echo canceling, thereby increasing channel density, optimize scalable design of the chip and avoid large on-chip logic and memory that is typically required in digital echo cancellers. On-chip filters along with external components are used to perform the fax/data tone and DTMF detection. The echo canceller uses an accelerator made of charge coupled analog delay lines (instead of memory blocks) and floating diffusion amplifiers to convert charge to voltage, which voltage is then fed to the on-chip analog multiplier and summing amplifier. In this manner, the echo canceller is highly scalable and performs the traditional echo canceling functions on a chip. The echo canceller can be scalable up to at least 672 channels per chip and can handle, for example, 64-128 ms of echo tail length. Also, the algorithm partition is optimized between the programmable DSP and/or the CPU in the VoIP and/or VoATM ASIC and an analog/mixed signal accelerator to calculate the echo estimate and the update the coefficients of the filters.

FIG. 6 illustrates an implementation of a digital line echo canceller (LEC) in accordance with the preferred embodiment of the present invention. As illustrated, the digital system includes multiple delay lines within delay block 100, which is described in greater detail later herein. The delay lines receive the far end signals and process them before transmitting them to an MAC (media-specific access control protocol) block 102. The MAC block 102 also receives coefficients from a coefficient memory block 104. These coefficients are constantly updated using a predictor block 106 and a normalization block 110. Preferably, the predictor block 106 implements LMS algorithm, and the normalization block 110 implements the normalization function.

The predictor block 106 uses an LMS or other conventional algorithm to calculate the coefficients based on the voice signals. These coefficients are estimated using the following formula: ak(1+1)=γak(l)+2B*e(l)*y(l−k). The value of the filter coefficient ak(1+1) depends on its previous value ak(l) and the product of Beta (B), the previous echo cancellation error e(l), and samples of signal ‘k’. In greater detail, e(l)=actual_echo (l)−estimated_echo (l), gamma γ≈1, Beta B=u/(ε+∥yₖ∥²), u≈0.7-1.0, ε≈0.0003 and ∥yₖ∥² is the energy of the far end signal, where ∥yₖ∥²_{new}=∥yₖ∥²_{old}−|last entry|²+|new entry|².

The echo estimator function includes the filters and the MAC block 102. The echo_estimate(l)=a1*y(1−1)+a2*y(1−2)+a3*y(l−3) . . . a128*y(1−128), or up to 512 samples. From the previous formula, the echo is estimated from the previous samples of the far end signals. In this example, 128 samples are selected from the 800 stored samples to estimate the echo. The 128 or n samples that are selected are dependent on the distance of the LEC from the near-end hybrid and are calculated by establishing which of the 128 samples out of the 800 have the highest correlation with the near end return signals. These 128 samples are also used in the predictor block 106 when there is silence at the near end. However, since the distance between the LEC and the near end hybrid is a constant value, the window predictor that indicates which of the 128 or n out of 800 samples to select maintains a constant value. The estimator in the delay block 100 consists of 128 or n tapped delay lines, which are implemented as an array of 128 or n registers loaded from the coefficient memory (storage RAM) 104. The coefficient memory 104 is preferably 800 words long and 2-bytes wide.

A voice activity detector (VAD) 108 is used to detect whether voice signals are present among the two subscribers. A predetermined threshold level is established based on the signal power/noise ratio. Signal strengths falling below the threshold level are assumed to indicate that silence is at the near end position. If silence is detected, a pulse signal is generated to trigger the updating process of the coefficient registers with the newer values in the predictor block 106.

The LEC interfaces with the other communication blocks using asynchronous DataReady signals, which indicate the availability of data for the LEC. The LEC design can also make use of the available FIFOs in the other communication blocks.

The delay block 100 is preferably represented as digital memory delay lines. These delay lines are replaced in the present invention with charge coupled device delay lines, i.e., they replace the larger SRAM block that is typically required for the implementation of the far end voice history delay line. This condition is similar for the coefficient memory block 104, which is represented as the coefficient delay lines. In the digital implementation, both the delay block 100 and the coefficient memory block 104 are preferably dual port SRAM with individual address decoding logic. The dual port SRAM occupies larger physical space on the chip and consumes high power for simultaneous read/write operations.

In addition to the components and blocks illustrated in FIG. 6, a digital signal (DSP) processing core is used. The DSP core is preferably a 16-bit fixed, programmable processor having a nonlinear processor (NLP), power estimation module (PEM), double talk detector (DTD), voice activity detector (VAD) and comfort noise generator (CNG), which are described in greater detail later herein.

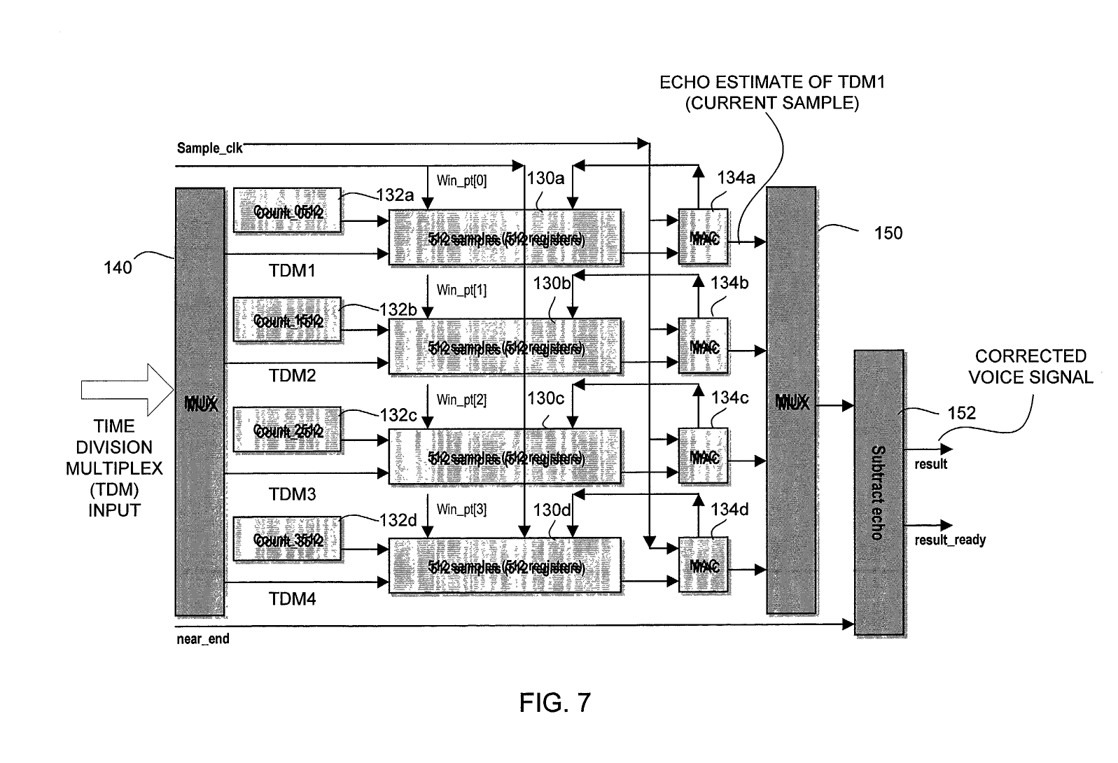

FIG. 7 illustrates a more detailed diagram of the delay block 100 and MAC block 102 for large channel density in accordance with the present invention. Each register 130a-130d inputs signals from the far end subscriber, counters 132a-132d, respectively, and MUX 140. The registers 130a-130d then output signals to MACs 134a-134d, respectively, which then sends the signals to the MUX 150. The output from the MUX 150 and the near end signals are fed into the substractor 152 for subtracting the echoes from the path. Each of the registers 130a-130d includes 512 samples of data. In this figure, four separate MACs 134a-134d and eight separate dual port voice history and coefficient memories are required. The coefficient delay lines and some inputs to the MACs 134a-134d are not shown in this figure for simplicity. Again, one object of the present invention is to reduce the physical area occupied by the digital memories and MACs.

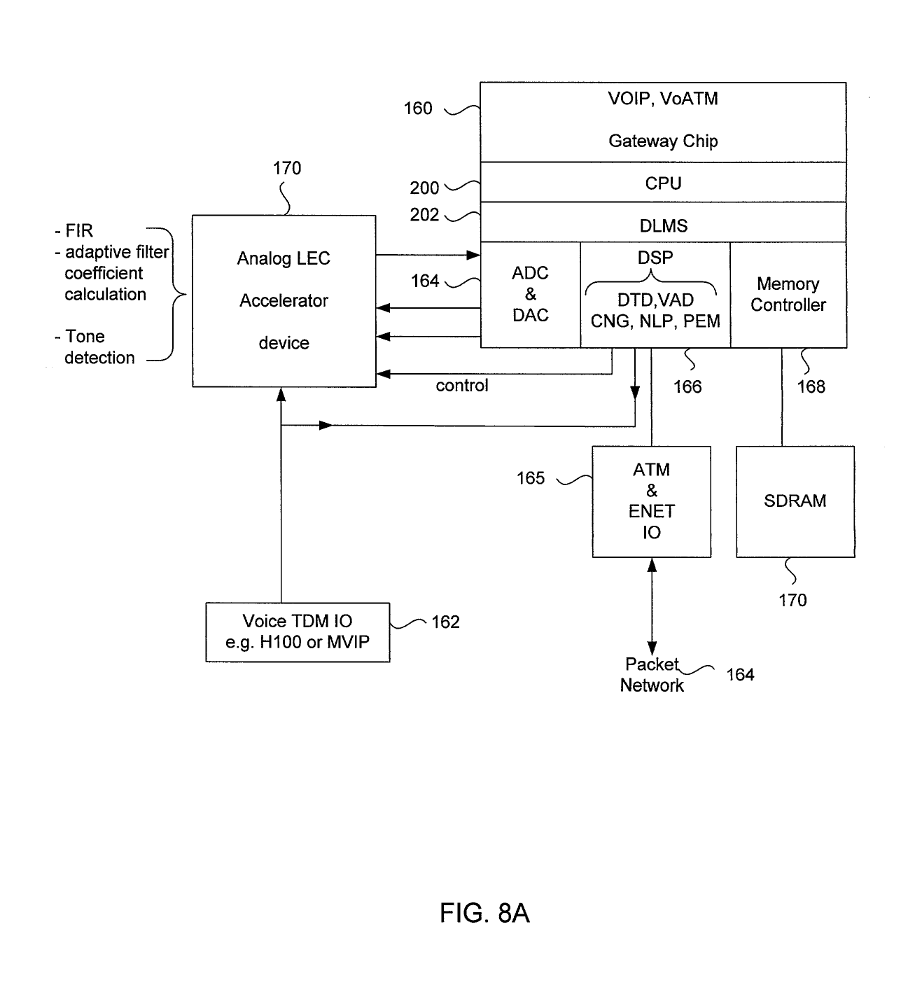

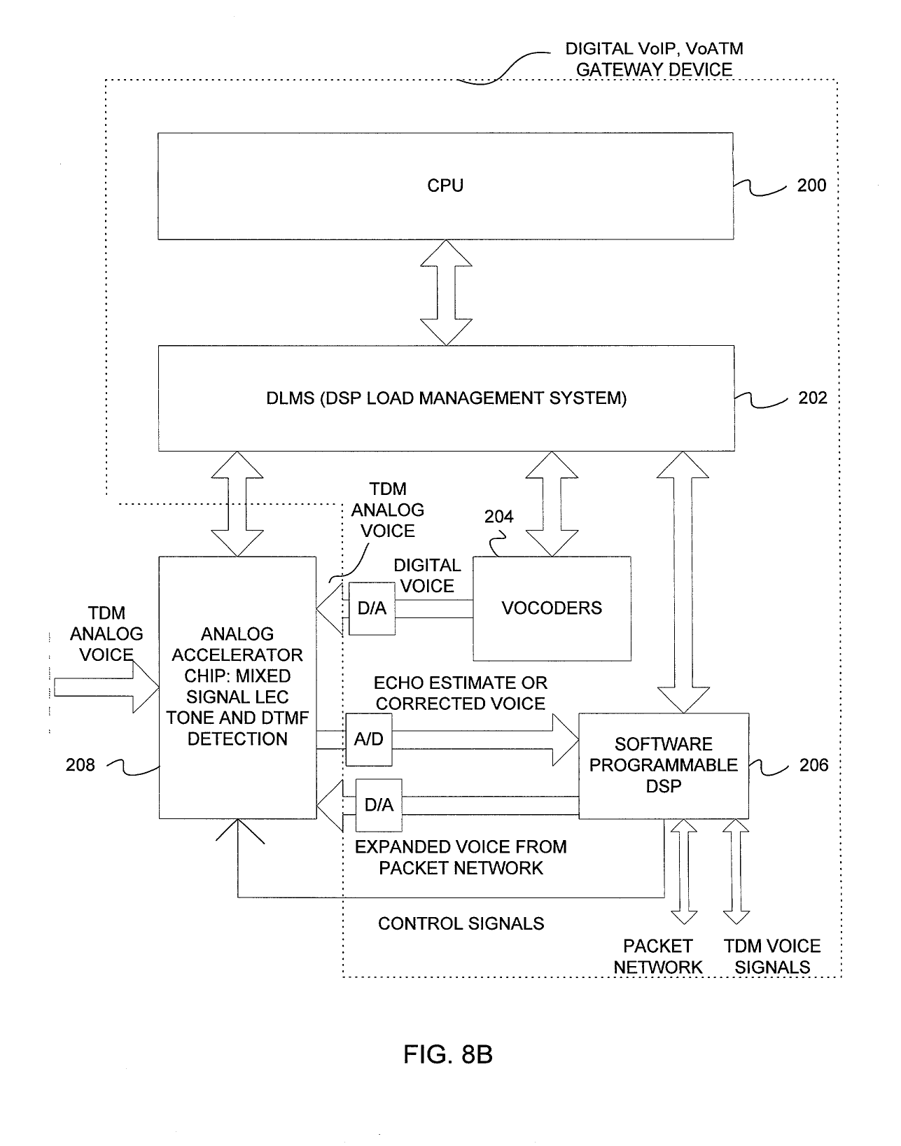

The mixed signal implementation of the LEC will now be described with reference to the following figures. FIG. 8A illustrates a system level block diagram in accordance with a preferred embodiment of the present invention. A gateway device 160 includes a CPU 200, a DSP load management system (DLMS) 202 (see below), ADC (analog to digital converter) and DAC (digital to analog converter) 164, a DSP 166, and a memory controller 168. The gateway device 160 interfaces to both the voice TDM network 162 and the packet network 164 via the ATM & ENET IO 165.

As described above, the DSP 166 core performs the control function, voice activity detection function (VAD), the double talk detection function (DTD), signal power estimation function (PEM), and nonlinear processor (NLP) function and comfort noise generation (CNG). An analog accelerator 170, which communicates with the gateway device 160, performs the function of normalized least mean square (NLMS) FIR filter and adaptive filter coefficient estimation as well as tone/DTMF detection. The memory controller 168 controls the SDRAM 170.

The NLP function of the DSP 166 is designed to either set the output to equal the input or set to zero. If the output is set to zero, then the CNG is enabled. The NLP is implemented in either fixed or adaptive manner. In fixed NLP, the nonlinear processing is activated if the power of the error signal is smaller than, for example, 35 db. The adaptive NLP would adjust the activation threshold depending on the level of the far end signal, e.g., 20 db below the power of the far end signal.

The LEC in the mixed signal environment uses transversal filters based on charged coupled devices (CCD) and analog sampled data. The optimal design rule parameter is between 0.25 to 1.25 micron and has a target frequency of about 10 MHz. The CCD registers can be clocked at 40 MHz. The LEC uses one or more summing op amps to calculate the echo estimate, and more importantly, uses digital gain and offset correction of the analog multipliers to achieve precise processing and compensation of component variation and parasitic effects. 12-16 bit accuracy is possible with large CCD pixel and low dark current process.

FIG. 8B illustrates a mixed signal implementation of an LEC in accordance with the preferred embodiment of the present invention. It is understood that the components described hereinafter with reference to FIG. 8B are on two chips. As illustrated, the CPU 200 communicates directly with the DSP load management system (DLMS) 202, which is described in greater detail in the co-pending U.S. application Ser. No. 09/498,525, entitled “Real Time DSP Load Management System”, the contents of which are expressly incorporated herein by reference. The DLMS 202 further communicates with vocoders 204, a software programmable DSP core such as a Carmel C10xx 206, and a mixed signal LEC and tone/DTMF detection block 208, also known as the analog accelerator chip. The CPU 200, DLMS 202, vocoders 204, and the DSP 206 make up the digital portion, and the analog accelerator chip 208 makes up the analog portion of the mixed-signal device. Whereas the function of the analog accelerator chip 208 is to perform echo filter convolution and coefficient prediction and tone detection, some of the functions of the DSP 206 in the gateway device include the following: (1) whether to freeze or not continue updating the weights of the adaptive filter under single and double talk conditions; (2) whether to continue calculating echo estimates or set the output to zero under tone detection conditions; and (3) whether to enable the nonlinear processing function (NLP).

In greater detail, the analog accelerator chip 208 receives digital voice signals from the vocoders 204 and analog voice signals directly from the TDM communication link from many subscriber channels. The analog accelerator chip 208 further communicates with the DSP 206 to transmit/receive echo error estimates and expanded voice signals from the packet network, respectively.

The LEC delay line in the analog accelerator chip 208 is preferably a CCD or switched capacitor device that can provide an analog delay line representing voice samples with 12-16 bits of accuracy. The LEC filter requires a minimum of 9-10 bit accuracy to achieve 35 dB echo attenuation, of which 6 dB out of the 35 dB originates from the reflection coefficient of the hybrid.

The analog accelerator chip 208 is preferable to other digital chips for various reasons. For one, the analog accelerator chip 208 can be easily scaled to a large number of channels (i.e., 600-700), thereby removing/eliminating large on-chip SSRAMs required to store far end voice history samples as well as filter coefficients. It is also noted that off-chip SDRAMs for the LEC is not feasible since large amount of memory threads and hence long arbitration delays are required. It is preferably to keep the memory within the chip or transfer bursts of data from SDRAM to on-chip cache for processing. A digital implementation of 672 channel LEC will generally require 3-4 memory controllers and SDRAM banks.

High accuracy multipliers can also be implemented in the analog accelerator chip 208 using a control code supplied by the DSP 206 and/or the CPU 200. Errors can be corrected using the digital portion of the device. The analog accelerator chip 208 is generally a “slave” to the DSP 206 of the gateway device to run a higher level of verification and to control algorithms. The analog accelerator chip 208 size and power dissipation is also lower than a digital LEC.

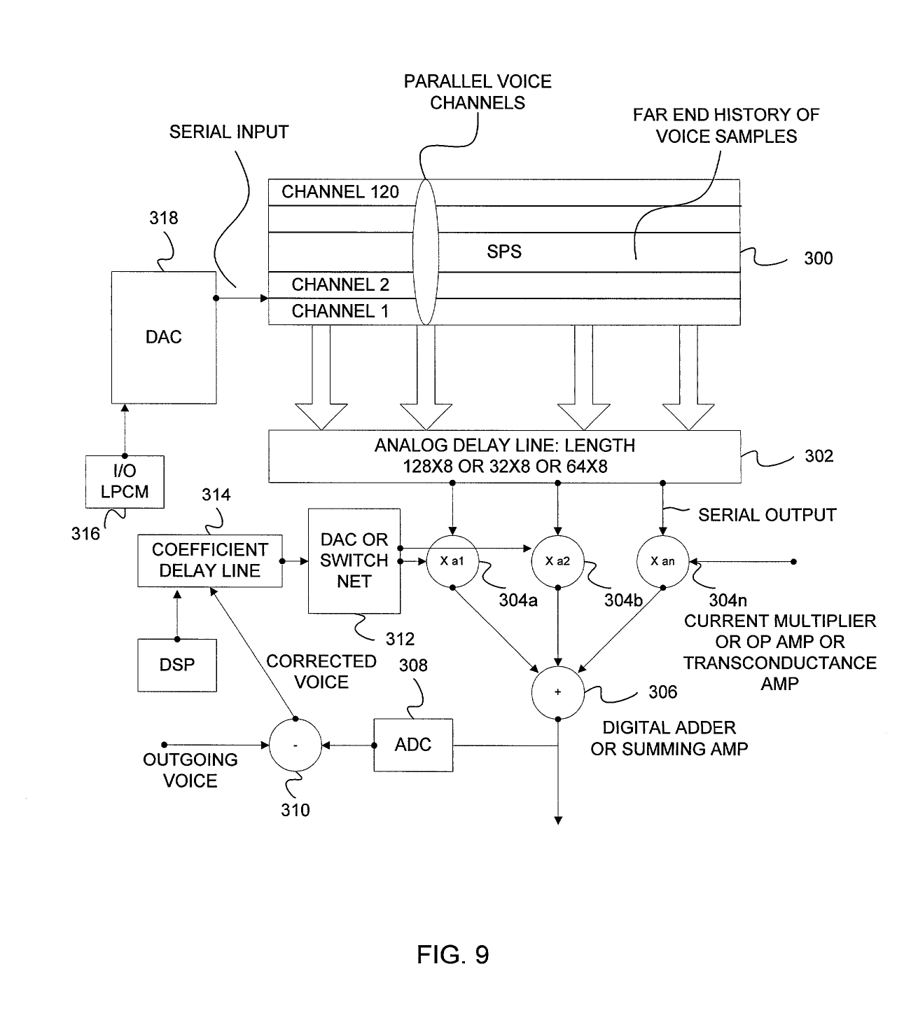

FIG. 9 illustrates a more detailed block diagram of the analog accelerator chip in accordance with the preferred embodiment of the present invention. In the preferred embodiment, an LPCM I/O (Linear PCM I/O) 316 transmits voice signals to the digital to analog converter (DAC) 318. The DAC 318 runs at a frequency of 8 KHx×N channel to convert either linear pulsed code modulation (LPCM) or A/u law input into analog signals.

The analog accelerator chip also includes or interfaces with a 12-13 bit ADC 308 running at a frequency of 8 KHx×N channel. The output of the analog accelerator chip is the echo estimate or corrected voice signal. This output is preferably connected to the digital gateway chip. The CCD or switched capacitor devices provide the analog delay line 302 length of 120 channels×8 samples/ms×tail length of 32 ms×2 B/sample (i.e., 250 KB).

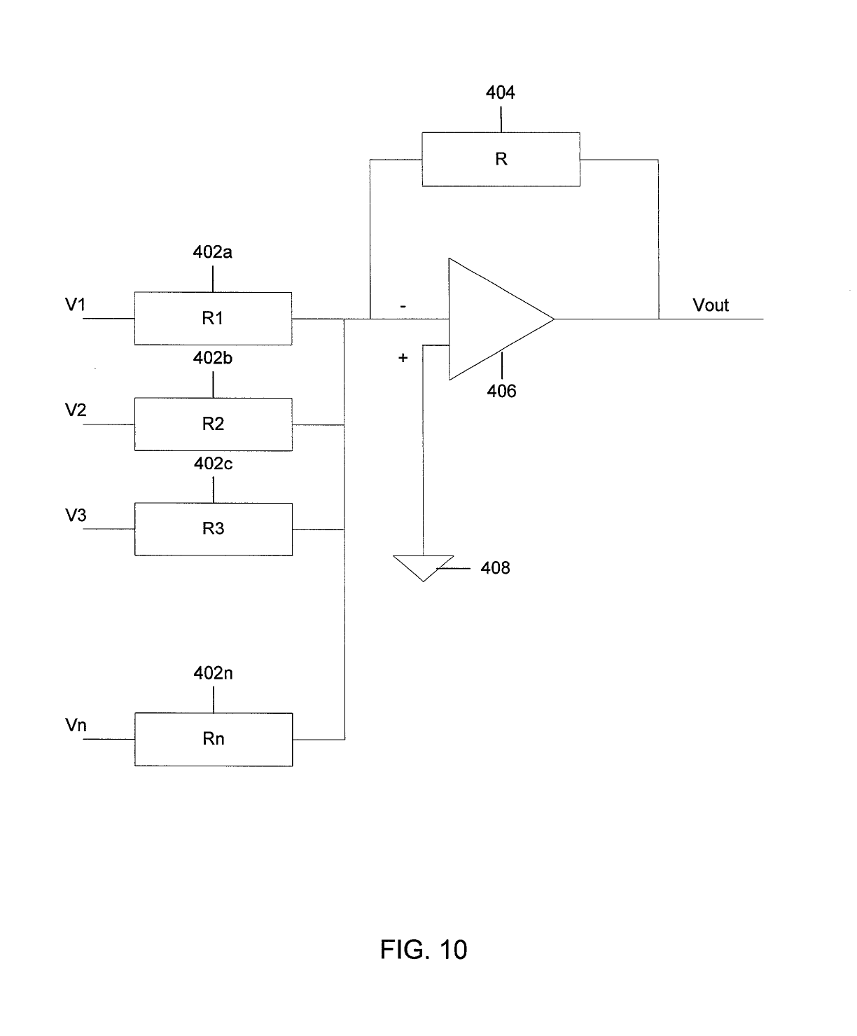

The SPS (CCD serial-parallel-serial array) block 300 communicates directly with the analog delay line 302. Various voice signals are delayed so that there is a history of 32-128 ms of signals. When one channel is being processed, it is loaded into the analog delay line 302, which is connected to one or more multipliers 304a-304n. The one or more multipliers 304a-304n multiply the coefficients and convert them to digital signals before transmitting them to an adder 306 or sums up the components using one or more summing amplifier as shown in FIG. 10. The digital coefficients are supplied per channel from a digital gateway chip and are supplied either in real time or converted to analog form and stored in the coefficient delay line 314. The analog delay line, multipliers and adders should all achieve a minimum of 9-10 bit accuracy and resolution.

The multiplication is performed using either trans-conductance or op amps. An example of an analog multiplier that can be used in the present invention is the RC4200 by Fairchild Semiconductor. The resistor network that controls the gain is adjusted by a code delivered from the DSP. This code is used to switch on/off a series of several size parallel NMOS transistors to modify the bias point and the gain of the trans-conductance amplifier.

FIG. 10 illustrates a diagram of a summing op amp in accordance with the preferred embodiment of the present invention. The summing op amp includes resistors R1, R2, R3, . . . Rn, connected in parallel, which resistors are further connected to a first amplifier 406 and resistor R 404. The output of the amplifier Vₒᵤₜ is defined as follows: Vout=Σ−(RV₁/R1+RV₂/R2+ . . . +RVₙ/Rn), where Σ is defined as the sum of the input voltages V₁, V₂, V₃, . . . Vₙ.

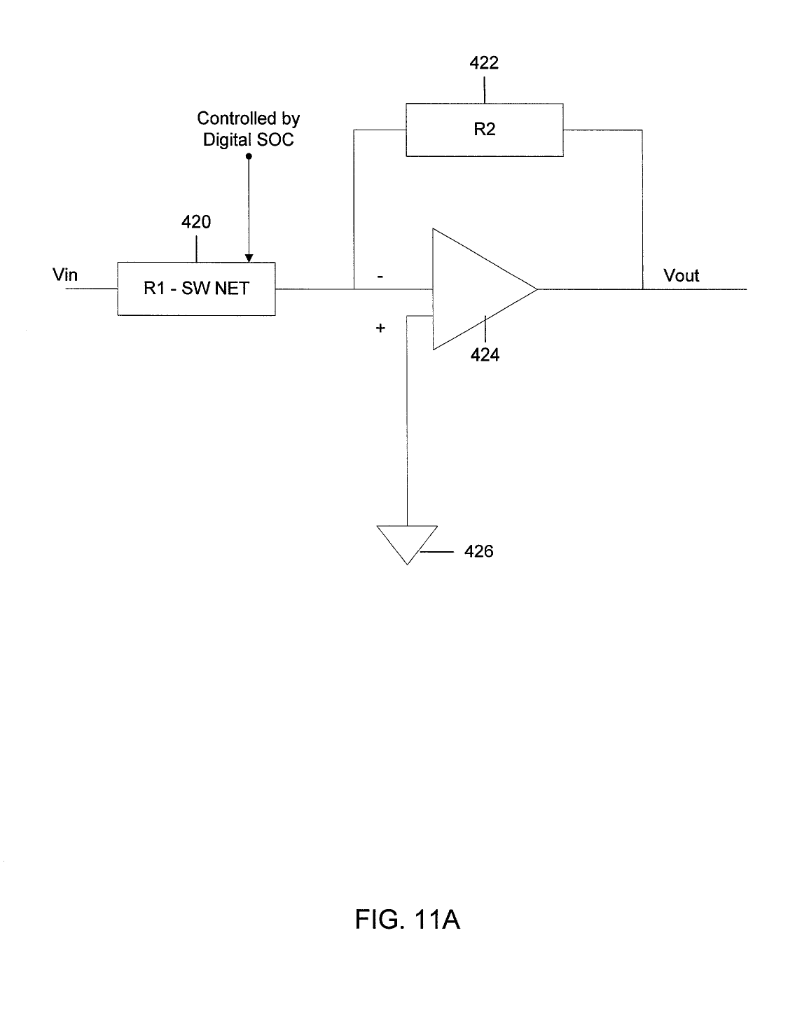

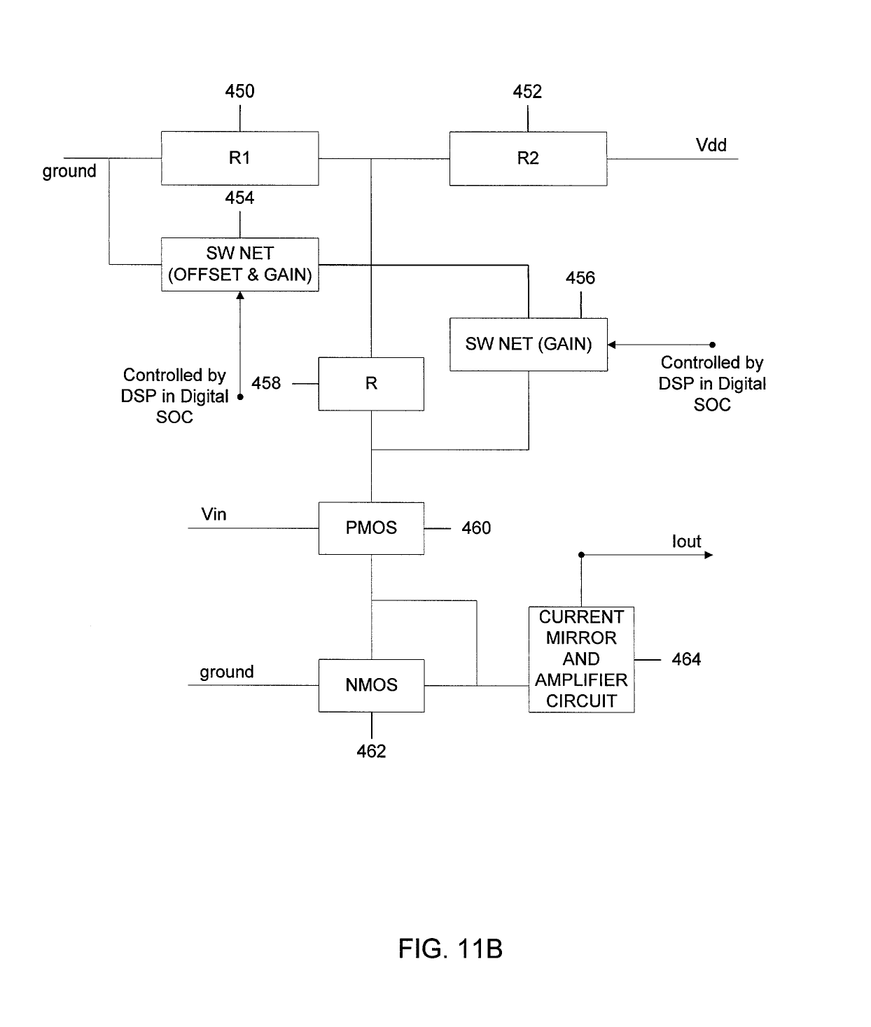

FIG. 11A illustrates an op amp gain control in accordance with the preferred embodiment of the present invention. Another method for performing the echo filter convolution is by using digital code that was calculated using the FIR filter coefficients. Different size switches or transistors are turned on/off transistors using this code. A switching network (SW net) 420 having a resistor R1 is controlled by the DSP of the digital gateway as Vᵢₙ is inputted therein. The output from the SW net 420 is fed into the amplifier 424 and resistor R2 422 to generate a Vₒᵤₜ, which is equal to the Vᵢₙ times a variable adjustable gain.

FIG. 11B illustrates a code controlled trans-conductance amp in accordance with the preferred embodiment of the present invention. The trans-conductance amp method is implemented using resistors R1 450, R2 452, R 458, SW net 454, 456, PMOS and NMOS transistors 460, 462, and current mirror 464. Similar to the above implementation, the SW net 454, 456 are controlled by the DSP of the gateway circuit. The PMOS and NMOS transistors 460, 462 are connected to each other through their drains, and the gate of the transistors are coupled to the current mirror and current amplifier 464 for generating Iₒᵤₜ.

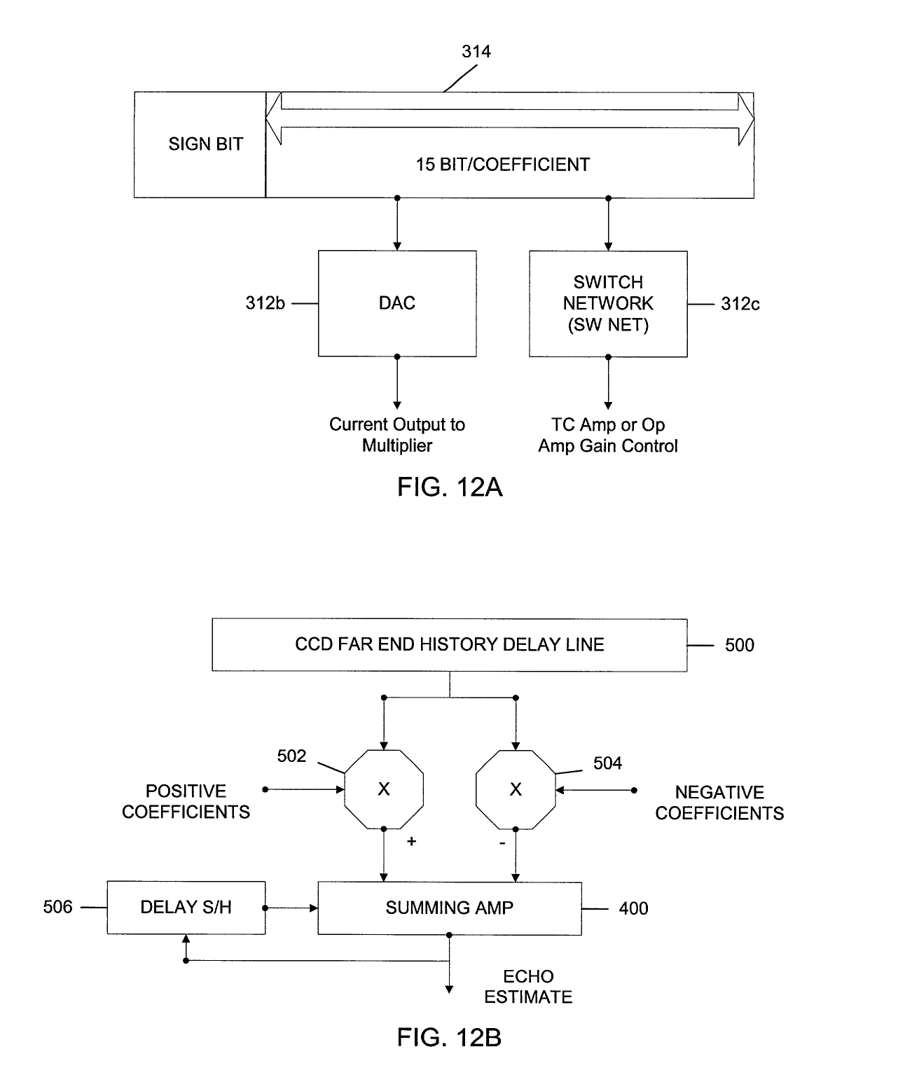

FIG. 12A illustrates a representation of coefficients in accordance with the preferred embodiment of the present invention. The 15 bit/coefficients from the packet network 314 are inputted into the DAC 312b or the SW net 312c. The DAC 312c outputs the analog signals to the current multipliers, and the SW net 312c outputs the signals to the switch network of the trans-conductance amp or op amp gain control (FIGS. 11A and 11B).

FIG. 12B illustrates a coefficient processing components in accordance with one of the preferred embodiment of the present invention. The positive coefficients are fed into a positive multiplier 502, and the negative coefficients are fed into a negative multiplier 504. Both multipliers 502, 504 are coupled to the CCD far end delay line 500 for receiving voice signals. The outputs from the multipliers 502, 504 are received by the summing op amp 400, as described above with reference to FIG. 10. The echo estimate is then transmitted to the subtractor (not shown). The delay S/H (sample and hold circuit) 506 is used for calculating error signals, by summing up the sequential negative and positive convolution components to generate the echo estimate.

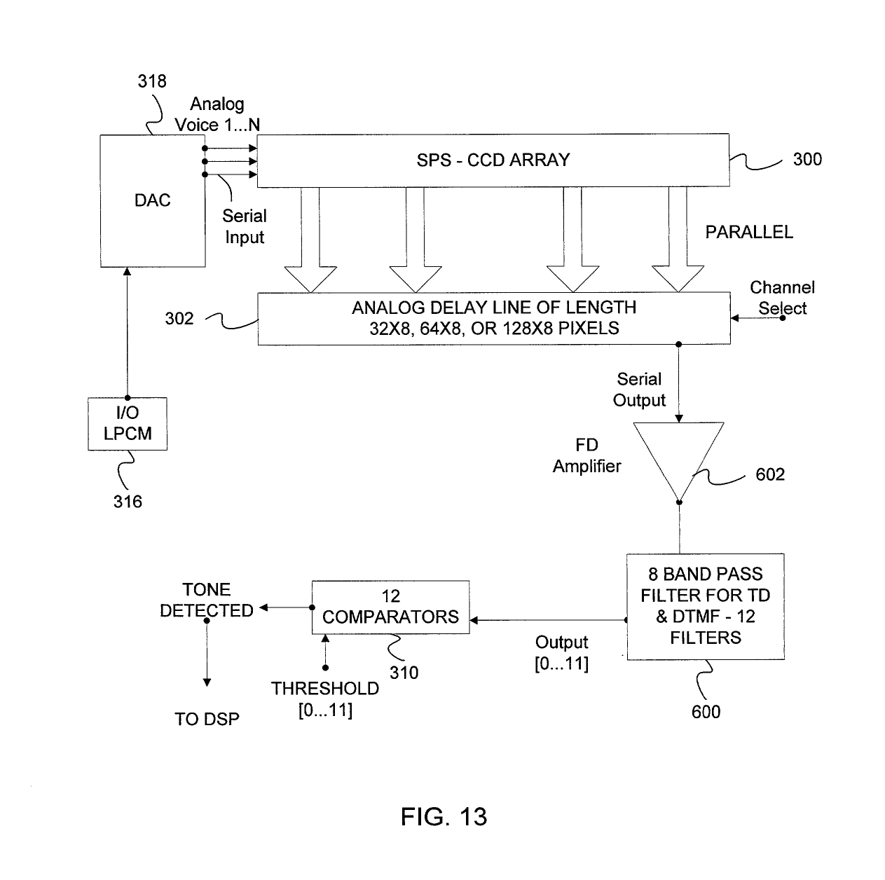

FIG. 13 illustrates an analog implementation of the fax/data tone detection and DTMF detection in accordance with the preferred embodiment of the present invention. The TD and DTMF detection on the LEC chip is performed using filters 600 and comparators 310. Comparators' signals are fed to the DSP to declare fax or modem call or to generate the ringing tone. Each dual tone multi-frequency (DTMF) tone is a combination of two sine waves of different frequency used for dialing telephone numbers. Each button on the telephone keypad generates a DTMF tone and is used for entering calling card numbers, controlling answering machines, voice mail, automated menus, and other system function. The tone detection TD of fax/modem is used to disable the echo convolution filter.

As is well known, DTMF tone generation and detection is a necessary process in VoATM/VoIP systems. The voice receiver VR DSP detects DTMF tones and sends them in packet form, whereas the voice transmitter VT DSP reads packet messages and synthesizes tones in circuit switched domain. Fax and data modems produce startup tones to negotiate connection parameters with the receiving modem. If the VoIP system detects fax and data modem tones, then it switches to non-parametric coders such as PCM or ADPCM. The DTMF transceiver of the analog accelerator is capable of decoding and generating all 16 DTMF tones.

Similar to the description above with reference to FIG. 9, an LPCM 316 transmits voice signals to the digital to analog converter (DAC) 318. The DAC 318 runs at a frequency of 8 KHx×N channel to convert either linear pulsed code modulation (PCM) or A/u law input into analog signals. The SPS (serial parallel serial CCD array) block 300 communicates directly with the analog delay line 302. The outputs from the analog delay line 302 is fed into an FD (floating diffusion) amplifier 602. Thereafter, pass band filters 600 receive the outputs from the FD amplifier 602 for detecting tones and output the filtered signals to the comparators 310.

FIG. 13 also illustrates that the output of the CCD array is used to read content of the far end voice history delay line. This output is wired to a floating diffusion output amplifier 602, which converts charge packet of the CCD to voltage. A typical conversion efficiency is 5-10 uV/electron. The output signal is filtered in a bank of filters connected in parallel for tone detection and DTMF. The filter output [0 . . . 11] is wired to 12 comparators 310. If this output exceeds a threshold, then the comparator 130 trips and informs the DSP on the gateway that tone has been detected. The DSP then generates appropriate controls to the filter upon tone detection.

In the previous descriptions, numerous specific details are set forth, such as specific functions, components, etc., to provide a thorough understanding of the present invention. However, as one having ordinary skill in the art would recognize, the present invention can be practiced without resorting to the details specifically set forth.

Although only the above embodiments have been described in detail above, those skilled in the art will readily appreciate that many modifications of the exemplary embodiments are possible without materially departing from the novel teachings and advantages of this invention.

I claim:

1. A digital echo canceller, comprising:
a delay block having delay lines for processing voice signals;
a media-specific access control (MAC) block coupled to the delay block for receiving the processed signals;
a coefficient memory block coupled to the MAC block, wherein the coefficient memory block transmits coefficients to the MAC block; and
a predictor block and a normalization block coupled to the coefficient memory block for updating the coefficients.

2. The echo canceller according to claim 1, wherein the predictor block implements a least mean square algorithm.

3. The echo canceller according to claim 1, wherein the normalization block implements a normal least mean square algorithm.

4. The echo canceller according to claim 1 further comprising a voice activity detector and a double talk detector for detecting voice signals from at least two sources.

5. The echo canceller according to claim 1, wherein the delay block comprises digital memory delay lines.

6. The echo canceller according to claim 5, wherein the delay lines comprises charged coupled delay lines.

7. The echo canceller according to claim 1, wherein the coefficient block comprises coefficient delay lines.

8. A mixed signal echo canceller, comprising:
a gateway device having:
a central processing device (CPU);
a DSP load management system coupling a digital signal processing (DSP), a memory controller, a digital to analog converter (DAC), and an analog to digital converter (ADC) to the CPU; and
an analog accelerator chip coupled to the gateway device.

9. The mixed signal echo canceller according to claim 8, wherein the DSP comprises a control function, voice activity function, a double talk detection function, signal power estimation function, nonlinear processor function and comfort noise generation function.

10. The mixed signal echo canceller according to claim 8, wherein the analog accelerator chip performs the function of normalized least mean square filtering.

11. The mixed signal echo canceller according to claim 8, wherein the analog accelerator chip performs the function of adaptive filter coefficient estimation.

12. The mixed signal echo canceller according to claim 8, wherein the analog accelerator chip performs the function of tone detection.

13. The mixed signal echo canceller according to claim 8, wherein the DSP is adapted to be software programmable.

14. An echo canceller for performing line echo cancellation, far end echo cancellation, acoustic and hybrid echo cancellation, noise processing, fax/data tone detection, and digital timing, comprising:
an accelerator having charge coupled delay lines and floating diffusion amplifiers to convert charge to voltage; and
an analog multiplier and a summing amplifier to receive the converted voltage from the accelerator.

15. An echo canceller according to claim 14, wherein the delay lines are multiplexed.

16. An echo canceller according to claim 14 further comprising on-chip filters to perform fax/data tone detection.
